(19) United States
(12) Patent Application Publication
(10) Pub. No.: US 2024/0315439 A1
(43) Pub. Date: Sep. 26, 2024

(54) MUSICAL TOOTHBRUSH ASSEMBLY

(71) Applicant: Xavier Bell, JR., Warrensville Heights, OH (US)

(72) Inventor: Xavier Bell, JR., Warrensville Heights, OH (US)

(21) Appl. No.: 18/125,482

(22) Filed: Mar. 23, 2023

(51) Int. Cl. A46B 15/00; A61C 17/34

(52) U.S. Cl. CPC A46B 15/0042; A61C 17/34

(57) ABSTRACT

According to a preferred embodiment, a toothbrush assembly is provided including a powered toothbrush having a body with a head for oral care with tooth cleaning elements and a handle. A removable storage unit forms a portion of the handle. A first power button and a second power button are provided. The powered toothbrush is paired with a blue tooth speaker for audibly transmitting digitally transmitted signals to the user's surroundings.

### FIELD OF THE DISCLOSURE

The present disclosure relates to a musical toothbrush assembly and in particular to a rechargeable toothbrush and charging dock with a Bluetooth speaker to play music.

### BACKGROUND OF THE DISCLOSURE

A kind of base of musical toothbrush, which is equipped with USB slot, loudspeaker, and bluetooth device. The base can pass through the music from the USB slot or the reception by way of the bluetooth device according to personal taste. When the toothbrush is extracted from base, the base automatically puts the music on.

Statistics show that only a small percentage of the population in any country brushes their teeth for the dentist recommended time of two minutes. This can be especially true of younger children and teenagers, who view tooth brushing as a mundane duty with few pleasurable aspects. Accordingly, there is a need to create an environment that makes tooth brushing enjoyable so that children and teenagers, in particular, will brush as often as they should and for the recommended period of time.

The primary purpose of a musical toothbrush is to provide a fun toothbrush that plays melodies while people and especially children brush their teeth. At the present time, there are limited alternatives that promote good oral hygiene in an entertaining way. One method is to provide a musical toothbrush which will be fun to use to allow children to learn the correct method of brushing their teeth in a distinctively enjoyable manner. Various toothbrushes have been proposed that play musical tunes while being used to encourage better oral hygiene.

What is needed is a toothbrush that can interest a child by playing one or more melodies that they want to hear, such as “Take me out to the ball game” and, when that melody finishes, plays “Twinkle, twinkle little star”. What is also needed is a toothbrush that can enhance the tooth brushing experience by glowing with one or more colors when brushing to provide visual effect, such as a toothbrush that glows a pleasing blue color when the child starts to brush and changes to a bright red or orange when the two minute brushing time has expired, but may continue to play melodies.

### SUMMARY OF THE DISCLOSURE

According to a preferred embodiment, a toothbrush assembly is provided including a powered toothbrush having a body with a head for oral care with tooth cleaning elements and a handle. A removable storage unit forms a portion of the handle. A first power button and a second power button are provided. The powered toothbrush is paired with a blue tooth speaker for audibly transmitting digitally transmitted signals to the user's surroundings.

Further according to a preferred embodiment a toothbrush assembly includes a powered toothbrush having a body with a head for oral care with tooth cleaning elements arranged on the head and a handle. A removable storage unit forms a portion of the handle. A first power button and a second power button are provided. The powered toothbrush is paired with a blue tooth speaker for audibly transmitting digitally transmitted signals to the user's surroundings. The tooth cleaning elements include tufts of bristles formed to have a number of different shapes and sizes and elastomeric cleaning members that can be formed to have a number of different shapes and sizes for use in providing oral health benefits. The powered toothbrush includes a power source that drives a powered element with a single activation/deactivation button.

### BRIEF DESCRIPTION OF THE DRAWINGS

The structure, operation, and advantages of the present invention will become further apparent upon consideration of the following description taken in conjunction with the accompanying figures. The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGS.) of the drawing, in which case typically the last two significant digits may be the same, the most significant digit being the number of the drawing figure (FIG.).

FIG. 1 is a three dimensional view of a toothbrush supported in a bluetooth speaker device in accordance with the present invention.

FIG. 2 is a side view of the surface of the toothbrush of FIG. 1 in accordance with the present invention.

FIG. 3 is a flow chart of an illustrative method for transferring music or audio from a signal source to a toothbrush in accordance with at least one embodiment.

### DETAILED DESCRIPTION OF THE DISCLOSURE

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

The following detailed description is not intended to be understood in a limiting sense, but to be an example of embodiments presented solely for illustration thereof, and by reference to which in connection with the following description and the accompanying drawings one skilled in the art may be advised of the advantages and construction of some embodiments. In the various views of the drawings, like reference characters designate like or similar parts.

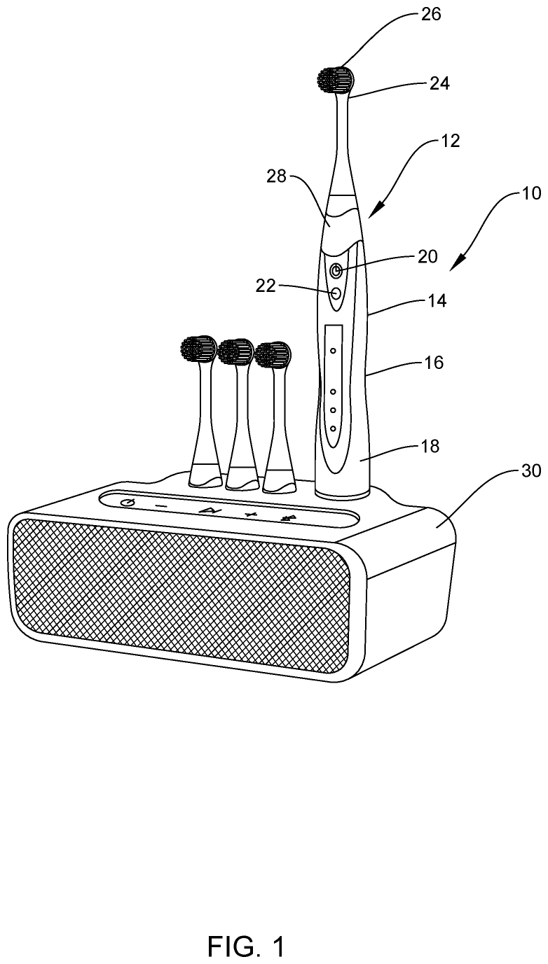

FIG. 1 illustrates a toothbrush assembly 10 in accordance with the present invention. The toothbrush assembly 10 includes a power toothbrush 12 having a body 14, a removable storage unit 16 that forms a portion of the handle 18, a first power button 20 and a second power button 22. The toothbrush 12 further comprises a head 24 or oral care region having tooth cleaning elements 26, and a handle 28. Head 24 may be replaceable, or it may be permanently attached to handle 28. As used herein, the term “tooth cleaning elements” or “cleaning elements” includes any type of structure that is commonly used or is suitable for use in providing oral health benefits (e.g., tooth cleaning, tooth polishing, tooth whitening, massaging, stimulating, etc.) by making contact with portions of the teeth and gums. Such tooth cleaning elements include but are not limited to tufts of bristles that can be formed to have a number of different shapes and sizes and elastomeric cleaning members that can be formed to have a number of different shapes and sizes, or a combination of both tufts of bristles and elastomeric cleaning members. The tooth cleaning elements may be arranged on head 24 as desired.

The toothbrush 12 may be a powered toothbrush including a power source that drives a powered element, such as movable cleaning elements 26 with a single activation/deactivation or “on/off” button 20.

Referring to FIGS. 1-3, the toothbrush assembly 10 also includes a blue tooth speaker 30 connected to an audio device (not shown) such as a smartphone capable of generating audio signals in digital form which are received by an input in the bluetooth speaker. The input can take on a variety of forms. For example, in one arrangement, the input may be paired with the speaker in the blue tooth speaker for audibly transmitting the digitally transmitted signals to the user's surroundings. The speaker 30 can be of sealed construction for water resistance. In addition, the blue tooth speaker 30 can power the any powered element in the toothbrush 12, such as for example, a vibration generator located in the handle to generate vibrations in the head 24.

The head 24 of the toothbrush 12 may comprise any known cleaning elements used in toothbrushes or other oral care implements, such as, but not limited to nylon bristles, tufts of bristles, bristle walls, elastomeric elements, and the like. The toothbrush 12 may include a motor/power source (e.g., motor and battery combination) that drives a shaft or rotor (not shown) for a powered element, such as movable cleaning elements 26 with a single activation/deactivation or “on/off” button 20. In an alternative configuration, toothbrush 12 may be a powered toothbrush including motor/power source that drives a powered element, such as movable cleaning elements 26 with an activation or “on” button 20 and a deactivation or “off” button 22.

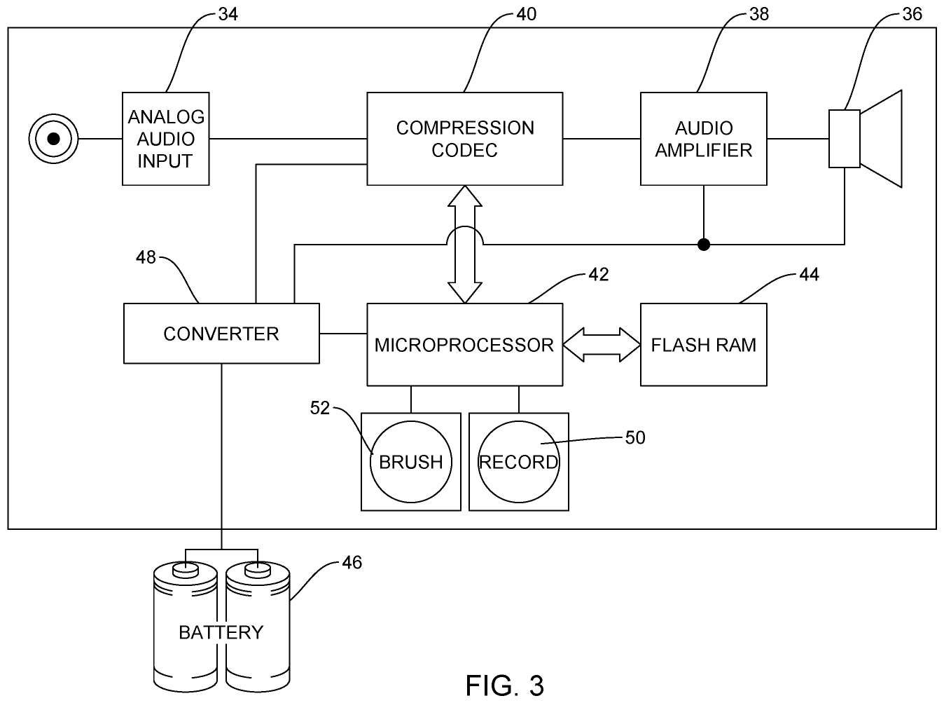

FIG. 3 illustrates an exemplary block diagram of components of a storage unit located in the speaker 30 in accordance with at least one embodiment. One or more of the components of FIG. 3 may be included within one or more printed circuit boards. An illustrative printed circuit board may be 18 mm×50 mm with a 16 kHz sample rate. As shown, the components of a storage unit may include an input plug in the form of a ⅛ inch stereo plug coupled to an analog audio input component 34. An integrated speaker 36, such as an 8 Ohm NXT speaker, may be coupled to an amplifier 38, such as a 2 watt audio amplifier. Input received from the input plug through the analog audio input component 34 is sent to a compression CODEC 40. Signal(s) for output are sent to the speaker 36 thought the amplifier 38 from the compression CODEC 40. Compression CODEC 40 is shown in communication with a microprocessor 42.

Microprocessor 42 is configured to perform all of the functions for processing signal(s), performing computer-readable instructions, and reading from and writing to a memory 44. As shown, microprocessor 42 communicates with a memory 44, such as a 2 MB flash RAM. Audio signals received via input plug 34 are stored in memory 44 and may be outputted to speaker 36. Power is provided by one or more batteries 46 to supply electrical power through a converter 48 to one or more components of the storage unit.

Recordation component 50 is shown coupled to microprocessor 42. Recordation component 50 may include instructions for the microprocessor 42 to record the audio signal(s) to memory 44 through input plug 34. Brush component 52 is shown coupled to microprocessor 42. Brush component 52 may include instructions for the microprocessor 42 to operate a motor (not shown) for a powered element (not shown) such as movable cleaning elements. As should be understood, instructions with respect to recordation component 50 and/or brush component may be included within memory 44 and/or some other memory, such as a ROM memory.

In one aspect, an oral care device, such as a toothbrush, a tongue cleaner, and/or a flossing device, may be configured to automatically record sound when the sound from a source device is detected. The sound from a source device triggers the oral care to record the audio signal, i.e., the sound.

In one aspect, an oral care device may include an oral care region attached to a body with a portion of the body being configured for gripping by a user as described herein. This oral care device may further include a memory within the body of the device. The memory may be configured to store one or more audio signals.

A processor, which may be located within the body of the oral care device, may be configured to automatically record to the memory an audio signal from an external audio source, such as an MP3 player, a CD player, a radio, a television, and a person's voice. The processor may be configured to automatically record when the audio signal is detected. As such, the detection of the audio signal triggers the recording of the signal without any user selection to actually record the audio signal. Finally, a speaker may be included in the oral care device to output the stored audio signal. Any of a number of components described herein may be included in such an oral care device as well. Such components include, but are not limited to a play button on the body configured to activate the processor to send the stored audio signal to the speaker, the oral care region including tooth cleaning elements, a power source within the body, the oral care region including at least one powered element, and various operational buttons to activating or deactivating powered elements and/or the output of stored audio signals.

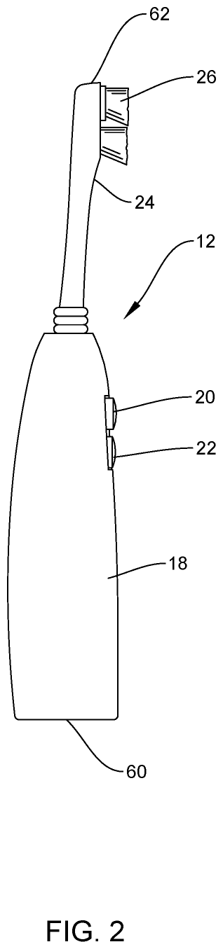

In one embodiment, referring to FIGS. 1 and 2, a ratio of the length of the neck and head 24 to the height of the toothbrush (measured from the distal bottom end 60 to the distal top of head 62) ranges from 1:10 to 2:5. In another example, the noted neck/head length to the toothbrush height ratio ranges from 1:20 to 1:30. Nevertheless, other values of the noted ratios are possible. In one embodiment, the external height of the toothbrush ergonomically sized for children ranges from about 160 mm to 200 mm. In other arrangements, the height of the toothbrush ranges from about 160 mm to 194 mm; to less than 194 mm or 190 mm. Nevertheless, other heights of the toothbrush assembly are possible. In one arrangement, the width of the handle 18 can range between 19 mm to 28 mm. In another arrangement, the depth of the handle 10 ranges between 19 mm to 27 mm. In other embodiments, the depth ranges between 19 mm to 21 mm. In a cylindrical configuration, the handle 18 may have a diameter ranging from 19 mm to 28 mm. Nevertheless, other values are possible. These ergonomic configurations provide for a toothbrush to have a neck/head length to reach within the depth of the oral cavity, while balancing the need for musculoskeletal strength of a child to manipulate the toothbrush. Accordingly, these configurations or combinations thereof enable an easily maneuverable electric toothbrush for children and provides for an enjoyable brushing experience to improve oral hygiene.

It is understood that designations such as “first” and “second” are for illustrative purposes and can be interchanged. While some embodiments have been described with respect to specific examples including presently preferred modes of execution, those skilled in the art will appreciate that there are numerous variations and permutations of the above described systems and techniques. Thus, the spirit and scope of the embodiments should be construed broadly as set forth in the appended claims.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A toothbrush assembly including:
a powered toothbrush having a body with a head for oral care with tooth cleaning elements and a handle;
a removable storage unit that forms a portion of the handle;
a first power button and a second power button; and
the powered toothbrush paired with a blue tooth speaker for audibly transmitting digitally transmitted signals to the user's surroundings.

2. The toothbrush assembly of claim 1 wherein the tooth cleaning elements are arranged on the head.

3. The toothbrush assembly of claim 2 wherein the tooth cleaning elements include tufts of bristles formed to have a number of different shapes and sizes for use in providing oral health benefits.

4. The toothbrush assembly of claim 2 wherein the tooth cleaning elements include elastomeric cleaning members that can be formed to have a number of different shapes and sizes for use in providing oral health benefits.

5. The toothbrush assembly of claim 2 wherein the tooth cleaning elements include tufts of bristles formed to have a number of different shapes and sizes and elastomeric cleaning members that can be formed to have a number of different shapes and sizes for use in providing oral health benefits.

6. The toothbrush assembly of claim 2 wherein the powered toothbrush includes a power source that drives a powered element with a single activation/deactivation button.

7. The toothbrush assembly of claim 6 wherein the toothbrush assembly includes a blue tooth speaker connected to an audio device capable of generating audio signals in digital form which are received by an input in the bluetooth speaker.

8. The toothbrush assembly of claim 7 wherein an input can be paired with the blue tooth speaker for audibly transmitting the digitally transmitted signals to the user's surroundings.

9. The toothbrush assembly of claim 8 wherein the blue tooth speaker can house a speaker of sealed construction for water resistance.

10. The toothbrush assembly of claim 9 wherein the blue tooth speaker can power the any powered element in the toothbrush.

11. The toothbrush assembly of claim 10 wherein the blue tooth speaker can power a vibration generator located in the handle to generate vibrations in the head.

12. The toothbrush assembly of claim 11 wherein the toothbrush may include a motor/power source that drives a shaft for movable cleaning elements with a single activation/deactivation button.

13. The toothbrush assembly of claim 12 wherein the toothbrush may include a motor/power source that drives a shaft for movable cleaning elements with an activation button and a deactivation button.

14. The toothbrush assembly of claim 12 wherein the toothbrush may include a motor and battery combination that drives the shaft for movable cleaning elements.

15. The toothbrush assembly of claim 10 wherein the blue tooth speaker includes a memory configured to store one or more audio signals.

16. The toothbrush assembly of claim 10 wherein the blue tooth speaker can be configured to automatically record to the memory an audio signal from an external audio source.

17. A toothbrush assembly including:
a powered toothbrush having a body with a head for oral care with tooth cleaning elements arranged on the head and a handle;
a removable storage unit that forms a portion of the handle,
a first power button and a second power button;
the powered toothbrush paired with a blue tooth speaker for audibly transmitting digitally transmitted signals to the user's surroundings;
the tooth cleaning elements include tufts of bristles formed to have a number of different shapes and sizes and elastomeric cleaning members that can be formed to have a number of different shapes and sizes for use in providing oral health benefits; and
the powered toothbrush includes a power source that drives a powered element with a single activation/deactivation button.

18. The toothbrush assembly of claim 17 wherein the toothbrush assembly includes a blue tooth speaker connected to an audio device capable of generating audio signals in digital form which are received by an input in the bluetooth speaker.

19. The toothbrush assembly of claim 18 wherein the blue tooth speaker can power a vibration generator located in the handle to generate vibrations in the head.

20. The toothbrush assembly of claim 19 wherein the toothbrush may include a motor/power source that drives a shaft for movable cleaning elements with a single activation/deactivation button.
